(19) United States
(12) Patent Application Publication
(10) Pub. No.: US 2005/0110268 A1
(43) Pub. Date: May 26, 2005

(54) Personalized medication card

(76) Inventor: Olga Maria Schone, Charlotte, NC (US)

Correspondence Address: Schwartz Law Firm, P.C.;SouthPark Towers, Suite 530, 6100 Fairview Road, Charlotte, NC, 28210, US

(21) Appl. No.: 10/718,895

(22) Filed: Nov. 21, 2003

(51) Int. Cl. G09C 3/00

(52) U.S. Cl. 283/75

(57) ABSTRACT

A personalized medication card for patients includes a listing of medicine pills to be taken by the patient, a color image of each pill, and instructions for administering the pills into the body.

### TECHNICAL FIELD AND BACKGROUND OF THE INVENTION

This invention relates to a personalized medication card for patients, particularly those who require multiple medicines at different times of the day. The invention offers clear and convenient means for identifying the medicines to be taken by the patient, and provides specific information regarding their dosage and administration.

Many of today's commercial pharmaceuticals are provided in the form of a colored pill or syrup. In some cases, the precise color of the medicine serves a trademark purpose of identifying and distinguishing its source. For example, the commercial heartburn medicine NEXIUM®) is marketed as the “Purple Pill” produced by AstraZeneca LP. As more and more pharmaceutical companies use the color and/or shape of pills in branding their products, consumers grow increasingly more reliant on these features to identify the medicines they take. Aside from branding, a recent study reported in the British Medical Journal suggests that other reasons exists for providing pills in various colors. According to the study, the perceived effects of color show that red, orange, and yellow pills are best for stimulant drugs and that blue and green pills are best for sedative drugs.

As a result of this increased significance of pill color and shape, a need exists for a personalized patient medication chart which clearly identifies prescribed medicines in an exact color representation. The invention virtually eliminates any confusion regarding which pills to take when, and reduces the likelihood of mistakes made in the administration of multiple different medicines.

### SUMMARY OF INVENTION

Therefore, it is an object of the invention to provide a personalized medication chart which includes an exact color representation of medicines to be administered to the patient.

It is another object of the invention to provide a personalized medication chart which is easy to read.

It is another object of the invention to provide a personalized medication chart which incorporates an enlarged digital color photograph of each listed pill.

These and other objects of the present invention are achieved in the preferred embodiments disclosed below by providing a personalized medication card for patients. The card includes a listing of medicine pills to be taken by the patient, a color image of each pill, and instructions for administering the pills into the body.

According to another preferred embodiment of the invention, the card further includes the name of the patient.

According to another preferred embodiment of the invention, the card further includes the residence address of the patient.

According to another preferred embodiment of the invention, the card further includes information indicating a bodily disorder treated by a listed pill.

According to another preferred embodiment of the invention, the card further includes contact information of a care giver.

According to another preferred embodiment of the invention, the instructions indicate a number of pills to be taken in a single dosage.

According to another preferred embodiment of the invention, the instructions further indicate a quantity of medicine in each pill.

According to another preferred embodiment of the invention, the instructions further indicate a time for taking each pill.

According to another preferred embodiment of the invention, the listing includes a commercial brand name for each pill.

According to another preferred embodiment of the invention, a card date indicates when the card was printed.

According to another preferred embodiment of the invention, the card is divided into morning medications and night medications.

### BRIEF DESCRIPTION OF THE DRAWINGS

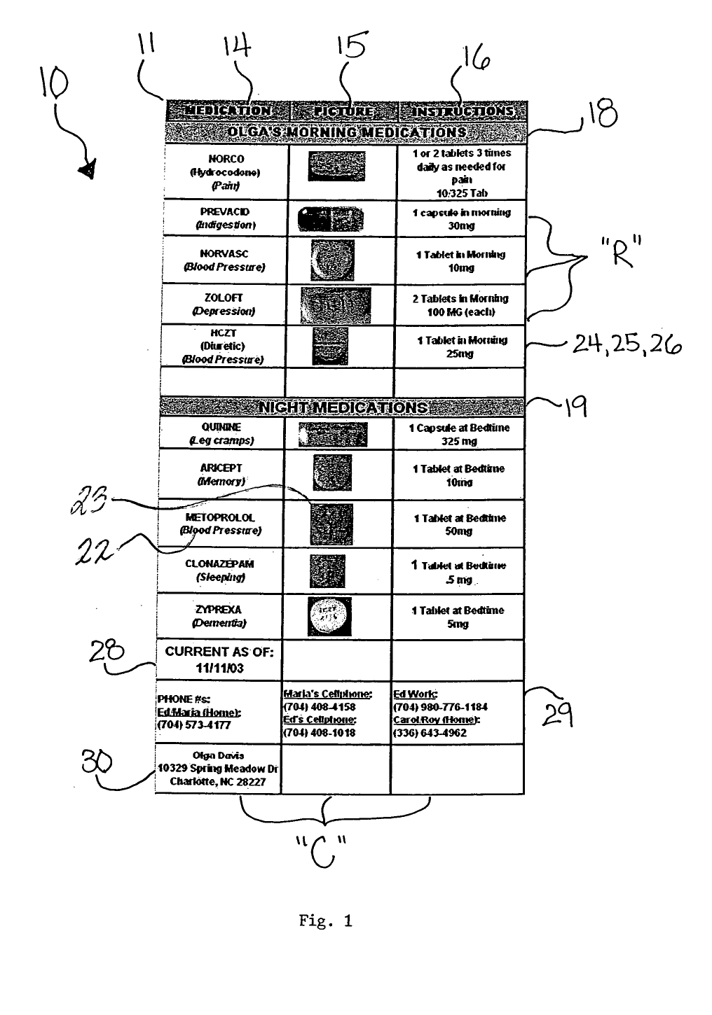

Some of the objects of the invention have been set forth above. Other objects and advantages of the invention will appear as the description proceeds when taken in conjunction with the following drawing, in which FIG. 1 shows a personalized patient medication card according to one preferred embodiment of the present invention.

### DESCRIPTION OF THE PREFERRED EMBODIMENT AND BEST MODE

Referring now specifically to the drawing, a personalized patient medication card according to the present invention is illustrated in FIG. 1, and shown generally at reference numeral 10. The medication card 10 provides a quick and easy-to-read reference which offers detailed information concerning medicines to be administered into the body of a patient. The medicines may be liquid syrups, injections, or pills. The term “pill” is defined broadly herein to include any self-contained quantity of medicine, such as provided in tablets, capsules, suppositories, and the like.

For convenience and readability, the medication card 10 is outlined in rows “R” and columns “C”. The top margin 11 of the card 10 has column headings for Medication 14, Picture 15, and Instructions 16. The Medication column 14 includes a written listing of medicines to be taken by the patient. This listing is divided into Morning Medications 18 and Night Medications 19, and preferably includes the commercial brand name 21 of each medicine together with a one or two word parenthetical description 22 of the aliment or disorder being treated. The Picture column 15 includes an exact color photo representation 23 of the medicine. For pills, this representation 23 identifies the medicine by the specific color and shape of the pill, and any distinctive indicia applied to the pill. In an alternative embodiment (not shown), for each medicine, the Picture column 15 includes images of the exact number of pills to be taken in a single dosage. The Instructions column 16 provides information for administering the medicine into the body. For pills, this information includes the number of pills to be taken in a single dosage 24, the time for taking each pill 25, and the quantity or concentration of medicine in each pill 26. Further useful information may include whether to take the medicine before or after meals. To avoid confusion and mistake, the above information for each medicine is provided in a single row “R” of the medication card 10.

Preferably, the bottom portion of the medication card 10 includes additional information, such as the date 28 the card was printed. This date 28 provides a “snap shot” of prescribed medications for the patient at a given time, and is especially useful for reference by physicians, nurses, and other care givers. Below the date 28, the card 10 further includes contact information 29 for care givers, family members, and other loved ones. This contact information 29 may comprise telephone numbers, e-mail addresses, and/or residence addresses. Finally, the medication card 10 provides the full name and residence address of the patient 30, and may also include a photograph of the patient.

A personalized patient medication card is described above. Various details of the invention may be changed without departing from its scope. Furthermore, the foregoing description of the preferred embodiment of the invention and best mode for practicing the invention are provided for the purpose of illustration only and not for the purpose of limitation-the invention being defined by the claims.

1. A personalized medication card for patients, comprising:
(a) a listing of medicines to be taken by a patient;
(b) a color image identifying each medicine; and
(c) instructions for administering the medicine into the body of the patient.

2. A personalized medication card according to claim 1, and comprising a name of the patient.

3. A personalized medication card according to claim 1, and comprising a residence address of the patient.

4. A personalized medication card according to claim 1, and comprising information indicating a bodily disorder treated by a listed medicine.

5. A personalized medication card according to claim 1, and comprising contact information of a care giver.

6. A personalized medication card according to claim 1, wherein said instructions indicate a quantity of medicine to be taken in a single dosage.

7. A personalized medication card according to claim 1, wherein said medicine is provided in pill form.

8. A personalized medication card according to claim 1, wherein said instructions indicate a time for taking each medicine.

9. A personalized medication card according to claim 1, wherein said listing comprises a commercial brand name for each medicine.

10. A personalized medication card according to claim 1, and comprising a card date indicating when said card was printed.

11. A personalized medication card according to claim 1, wherein said card is divided into morning medications and night medications.

12. A personalized medication card for patients, comprising:
(a) a listing of medicine pills to be taken by a patient;
(b) a color image of each pill; and
(c) instructions for administering the pills into a body of the patient, said instructions indicating a number of pills to be taken in a single dosage, and a time for taking each dosage.

13. A personalized medication card according to claim 12, and comprising a name of the patient.

14. A personalized medication card according to claim 13, and comprising a residence address of the patient.

15. A personalized medication card according to claim 14, and comprising information indicating a bodily disorder treated by a listed pill.

16. A personalized medication card according to claim 15, and comprising contact information of a care giver.

17. A personalized medication card according to claim 12, wherein said instructions indicate a quantity of medicine in each pill.

18. A personalized medication card according to claim 17, wherein said listing comprises a commercial brand name for each pill.

19. A personalized medication card according to claim 18, and comprising a card date indicating when said card was printed.

20. A personalized medication card for patients, comprising:
(a) a listing of medicine pills to be taken by the a patient, said listing comprising commercial brand names of respective pills;
(b) a color image of each pill;
(c) instructions for administering the pills into a body of the patient, said instructions indicating a number of pills to be taken in a single dosage, a time for taking each dosage, and a quantity of medicine in each pill;
(d) a name of the patient;
(e) a residence address of the patient;
(f) information indicating a bodily disorder treated by a listed pill;
(g) contact information of a care giver; and
(h) a card date indicating when said card was printed.
